(19) United States
(12) Patent Application Publication
(10) Pub. No.: US 2015/0088531 A1
(43) Pub. Date: Mar. 26, 2015

(54) SYSTEM AND METHOD FOR AUTOMATION OF PERSONAL HEALTHCARE

(71) Applicant: Virgil John Comanita, North Royalton, OH (US)

(72) Inventor: Virgil John Comanita, North Royalton, OH (US)

(21) Appl. No.: 14/032,654

(22) Filed: Sep. 20, 2013

(51) Int. Cl. G06Q 50/22

(52) U.S. Cl. CPC G06Q 50/22
USPC 705/2

(57) ABSTRACT

A system and method for accumulating, analyzing and reporting of medical information includes a data input and computer or server system in data connection with information sources, such as doctors, patients, labs, medical devises or the patient to provide personal healthcare guidelines or alerts. Information is accumulated over time, facilitating trend analysis and generation of readily-understandable displays by implementation of structured data display templates. Analysis of data facilitates generation of advice or suggestions for patient behavior. Reports are available for individuals, groups, medical institutions, healthcare providers or insurance companies.

### TECHNICAL FIELD

The subject application is directed generally to health monitoring. The application includes embodiments directed to monitoring healthcare over time, providing easy-to-understand reports, and identification or warning of possible problem areas.

### BACKGROUND

Healthcare continues to evolve to generate more and more patient data. Automation of medical records, implementation of health monitoring devices and data generated by exams, particularly by modern diagnostic equipment, work to provide large amounts of clinical data. Individuals, especially those without medical training or experience, find it difficult or impossible to understand the various test results, diagnoses, prescriptions, or other monitored or acquired data relative to their physiological condition.

### BRIEF DESCRIPTION OF THE DRAWINGS

FIG. 1 illustrates an example embodiment of a platform for acquiring, synthesizing, analyzing or reporting medical information;

FIG. 2 illustrates an example embodiment of a suitable processing platform for acquiring, synthesizing, analyzing or reporting medical information;

FIG. 3 illustrates an example of a flow diagram for acquiring, synthesizing, analyzing or reporting medical information;

FIG. 4 illustrates an example of a report output;

FIG. 5 illustrates another example of a report output;

FIG. 6 illustrates another example of a report output;

FIG. 7 illustrates another example of a report output;

FIG. 8 illustrates another example of a report output;

FIG. 9 illustrates another example of a report output;

FIG. 10 illustrates another example of a report output; and

FIG. 11 illustrates another example of a report output.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In an example embodiment described herein, a healthcare system includes logic operable to receive, from a third-party medical data source, medical data associated with an individual, the medical data including multiple instances of related data associated with the individual over time. A data storage stores received medical data, along with formatting data corresponding to at least one preselected data presentation format. The logic further analyzes the medical data for trends exhibited over time with the multiple instances of related data. The logic also determines a risk level of the individual in accordance with analysis of the medical data, and generates reports in accordance with the analyzed medical data. The logic further formats generated reports in accordance with the formatting data displays formatted reports to the individual.

In another example embodiment, a healthcare method includes receiving, from a third-party medical data source, medical data associated with an individual, the medical data including multiple instances of related data associated with the individual over time. Medical data is then stored in an associated data storage. Formatting data corresponding to at least one preselected data presentation format is also stored. The medical data is analyzed relative for trends exhibited over time with the multiple instances of related data, and a risk level of the individual is determined accordingly. Reports are generated in accordance with the analyzed medical data. These reports are formatted in accordance with the formatting data, and formatted reports are displayed to the individual.

In accordance with another example embodiment, a healthcare system includes an input operative to receive, from a health care provider, medical data associated with an individual, the medical data including multiple instances of related data associated with the individual over time, the medical data further including physical exam data associated with a physical exam of the individual and lab data associated with lab test results associated with the individual. This medical data is stored in a data storage. The data storage further includes formatting data corresponding to at least one preselected data presentation format. The logic analyzes the medical data for trends exhibited over time with the multiple instances of related data and determines a risk level of the individual in accordance with a statistical analysis. A reports is generated in accordance with the analyzed medical data in a format specified by the formatting data. An output communicates formatted reports to an associated web client in accordance with a web session initiated by the individual.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Medical data is available for individuals, as well as for groups, from a variety of sources. Medical data is available from an individual's own input, such as input regarding their physical state, mood, body temperature or blood pressure. An individual may also input data in accordance with answering questions or providing information into a preexisting template, such as a form or web page. Medical data is also available from doctor input, device input or input from labs or testing sites.

Patients may have access to all or some of their own data via computer records, paper records, or via databases that are accessible online. Online sources are becoming increasingly common, and may be accessible from a portal, such as MY CHART that is available from several medical institutions. Patient data may be highly confidential, particularly if associated with patient identity, and may be, subject to regulation under the Health Insurance Portability and Accountability Act (“HIPPA”). Online access to medical data or access via commonly accessible portals, such as a public terminal, will therefore typically require secure login before information access is afforded.

When a typical individual patient accesses their medical data, such as via the above-described web portal, the information available is typically provided in a form or format that renders it difficult or impossible for the individual to understand or interpret it. Listings of unrelated tests may appear together. Multiple tests, such as multiple instances of related tests, may appear as separate data records. With such a presentation, to the extent a patient can understand their information, it does not provide any useful guidance relative to past or current health status, or guidance, warning or suggestion relative to potential current or future health issues.

The subject application teaches examples of a medical data system and method that provides for accumulation, storage analysis and dissemination to individuals, such as patients, in an easily understood form or format. Further example embodiments include a system and method for generation of alerts or warnings based on medical data analysis, including analysis made on cumulative results for individuals, comparison of individual results with other patient information such as for other groups, such as peer groups. All or some of the above are also suitably relayed to other individuals, such as family members, healthcare providers or other designated or approved recipients.

Access to understandable, accurate and current medical information, particularly when coupled with historic medical information for comparison or trend analysis, helps alleviate effects such as rising cost in the healthcare industry, such as those costs associated with ineffective primary care. Patients are often not well informed relative to their medical conditions insofar as current practice simply involves generating medical data with little or no analysis and guidance for preventive care. By way of example, results of physical exams or a common diagnosis is simply “pass/fail.” Unfavorable trends for a patient's condition with respect to blood pressure, cholesterol, pulse, glucose, creatinine, potassium, sodium levels, and other common test results are often ineffectively communicated, or worse, not communicated at all.

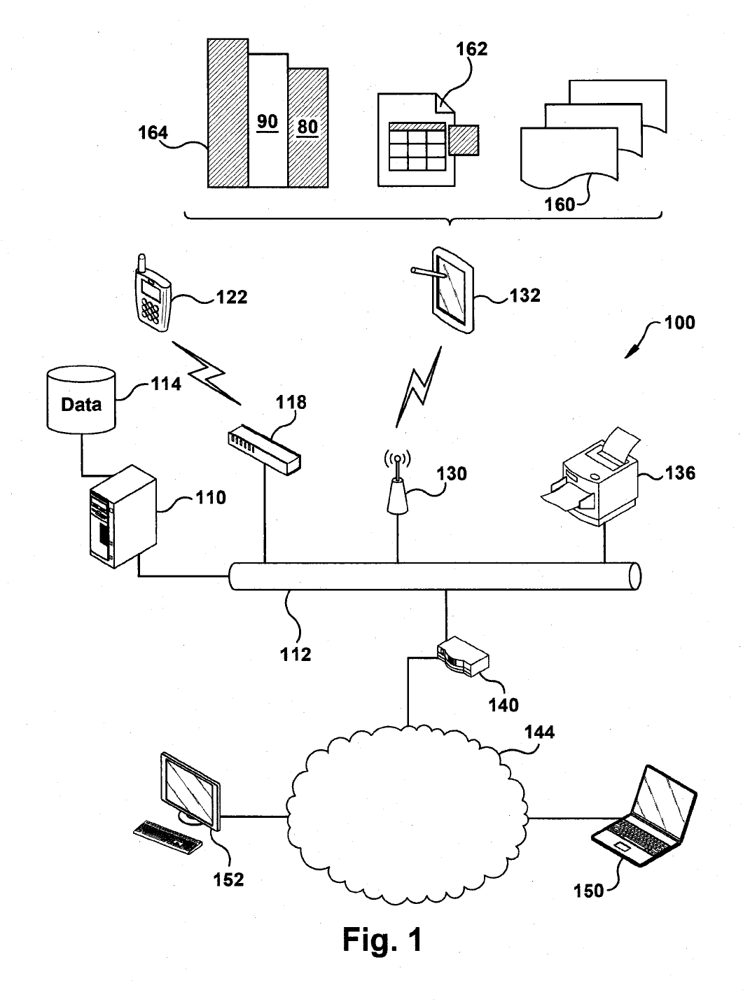

Turning to FIG. 1, illustrated is an example healthcare information system 100. In the illustrated example, one or more servers, such as server 110 are coupled to a network 112. Server 110 suitably includes a web server to communicate to thin client or browser based sessions as will be detailed below. Network 112, as well as other data connections noted in FIG. 1, is illustrated as hard-wired, such as with an Ethernet network. It will be appreciated that any suitable wireless or wired data network or connection is suitably employed.

Server 100 is in data communication with data storage 114 for storage of data, including medical data or output format template data, as will be detailed further below. Various data devices are illustrated in the embodiment of FIG. 1. A telephone connection, such as via PBX 118, provides for wireless or wired access to telephones, such as smartphone 122. Access point 130 suitably provides access to portable devices, such as via Bluetooth or WiFi. Representative devices include tablet computer 132, or other device such as a smartphone or notebook computer.

Also illustrated in the example of FIG. 1 is a peripheral 136, such as printer, scanner, copier or multifunction peripheral. A router 140 suitably provides data connectivity to an extranet, or to a wide-area network such as the Internet 144. Other devices, including devices such as that noted above, are suitably placed in data communication with the server 110. Representative, Internet-connected devices are illustrated with notebook computer 150 and desktop computer 152.

Also illustrated in FIG. 1 are examples of medical data, such as medical records. Medical data may also comprise test results, health monitoring device input, pharmacological data, or other pictorial, video or sound data, such as x-rays, CT scans, MRI scans and the like.

Medical information is usable to generate reports, including user-friendly, structured reporting forms. Included in FIG. 1 are example outputs such as a spreadsheet or chart 162 or graph 164. In the illustration, any or all of these example outputs are represented as being displayed by tablet computer 132, although it will be appreciated that any suitable data device can be used for input of data or display of medical data or reports. In addition to the forgoing, the server 110 suitably analyzes data results, trends in data or comparisons of data with that from others, and alerts or other notification are generated to one or more devices.

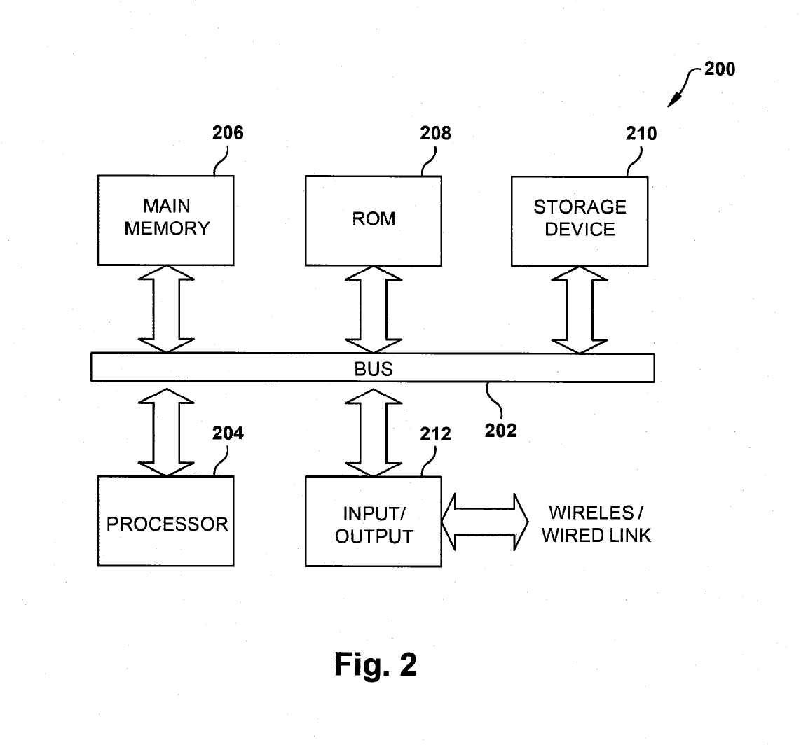

FIG. 2 is a block diagram illustrating an example of a suitable computer system 200, such as that used in connection with server 102. Computer system 200 includes a bus 202 or other communication mechanism for communicating information and a processor 204 coupled with bus 202 for processing information. Computer system 200 also includes a main memory 206, such as random access memory (RAM) or other dynamic storage device coupled to bus 202 for storing information and instructions to be executed by processor 204. Main memory 206 also may be used for storing temporary variable or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk, optical disk, and/or flash storage, is provided and coupled to bus 202 for storing information and instructions. An input/output unit 212 facilitates communication via keyboard, mouse, network interface, or any other device outside of the system 200.

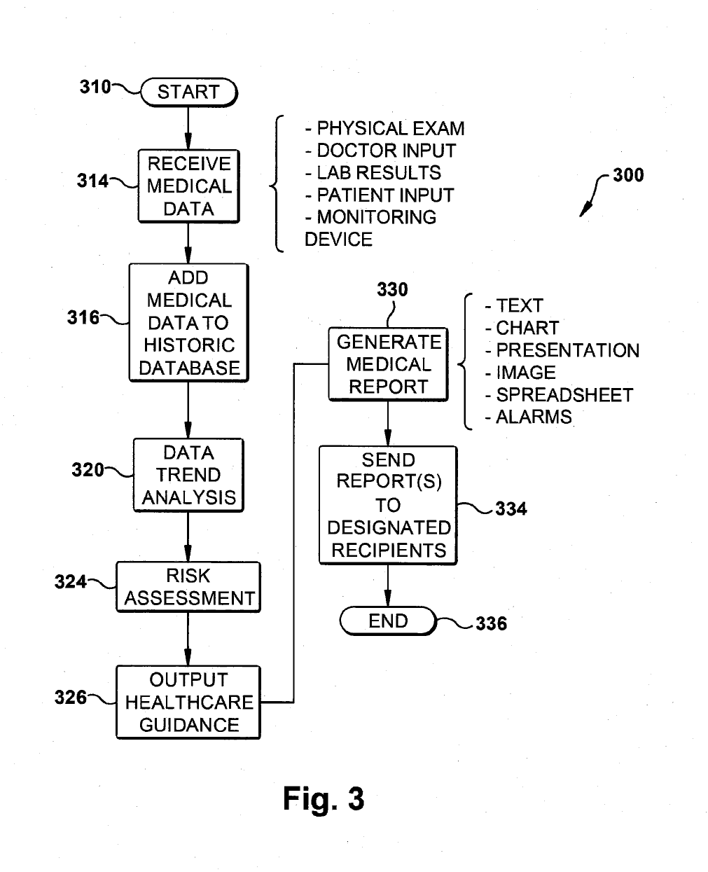

Turning next to FIG. 3, illustrated is an example flow diagram 300 in connection with implementation of the forgoing. A process or action is suitably commenced at 310. Medical data is received at 314. In the illustrated example, medical data suitably includes one or more of data from a physical exam, doctor input, lab results, patient input or input from a monitoring device. It will be appreciated that medical information may come from a myriad of sources, including but not limited to those sources noted herein. Medical data may also include data corresponding to studies, or previously acquired medical data from other parties or groups as well as algorithms related to analysis or diagnosing conditions as possible treatments.

Next, at 316, received information is added to a database. When data is added to the database after being loaded with earlier-gathered data from the same individual, data from other individuals or groups, or data representative of established data levels or indicators, additional analysis or reporting is facilitated.

Next, at 320 multiple data sets, such as that noted above, are suitably analyzed to determine trends. From such trend data, or from comparisons to data from others or with other data, an assessment of risk is made at 324. Such risk is suitably to one individual, to related individuals or to defined groups, as well as entities such as insurers. Association of such risk facilitates determining what guidance may be available, and information regarding the same is output at 326.

Next, at 330, a medical report or reports is suitably generated. In the example of FIG. 3, reports suitably include output such as text information, charts, and presentations, such as slides, movies or animations, images, spreadsheets or some combination thereof. Also, a medical report may comprise a warning, alarm or other indicator to draw attention of one or more recipients of a condition that requires faster attention. Output at 334 is suitably to one individual, to related individuals or to defined groups, or entities such as an insurance company or pharmacy. Output is suitably accomplished via e-mail, text messaging, web browser input, or any other suitable output generator. The process suitably terminates at 336.

As detailed above, user-friendly, concise or readily understandable output suitably follows one or more pre-established formats or templates. Implementation of such templates affords consistent, user-friendly, and easily understandable output or summary of medical information. Association and display of data in accordance with form or format noted below readily understood by one of ordinary skill in the art.

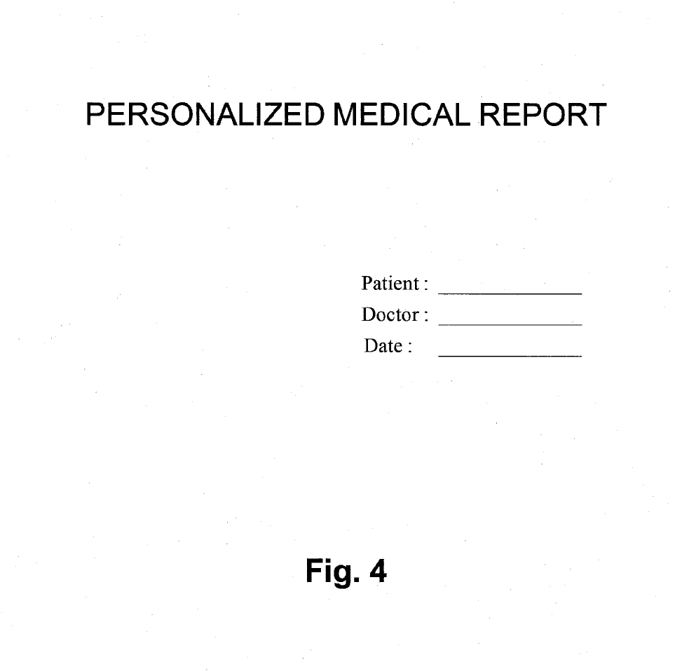

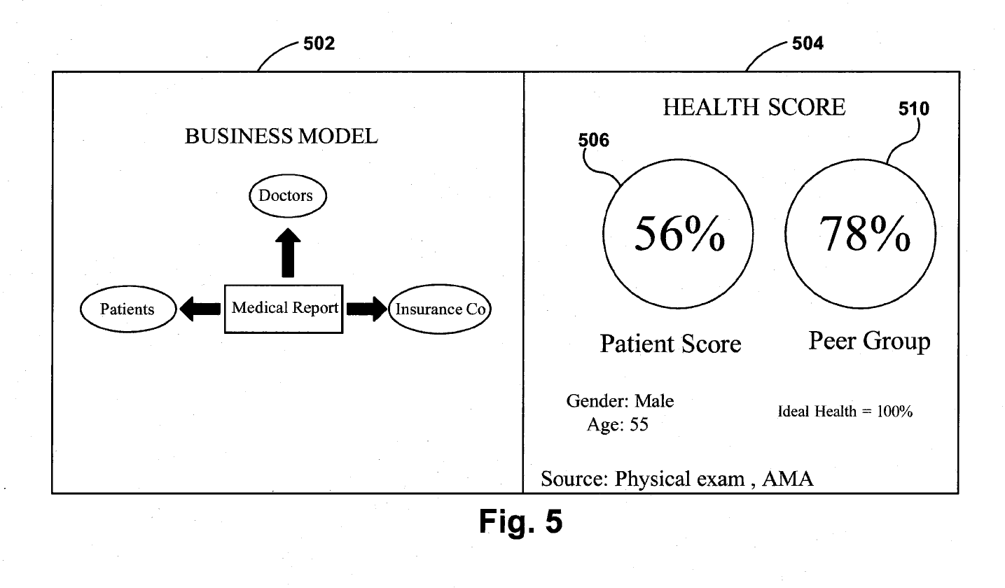

FIG. 4 illustrates an example of a straightforward medical record output, suitably employed as a title page or header to set up report information to follow. FIG. 5 illustrates an example report or output. Included in the example is a business model rendering 502, including visualization as to how medical reports are to be disseminated. Also included is a health score 504, suitably calculated as noted above from acquired or accumulated data. Such a heath score is suitably based on standards, such as that propagated by the America Medical Association. In the illustrated example, a patient score 506 is illustrated with that of a peer group in a compact, easily understood manner.

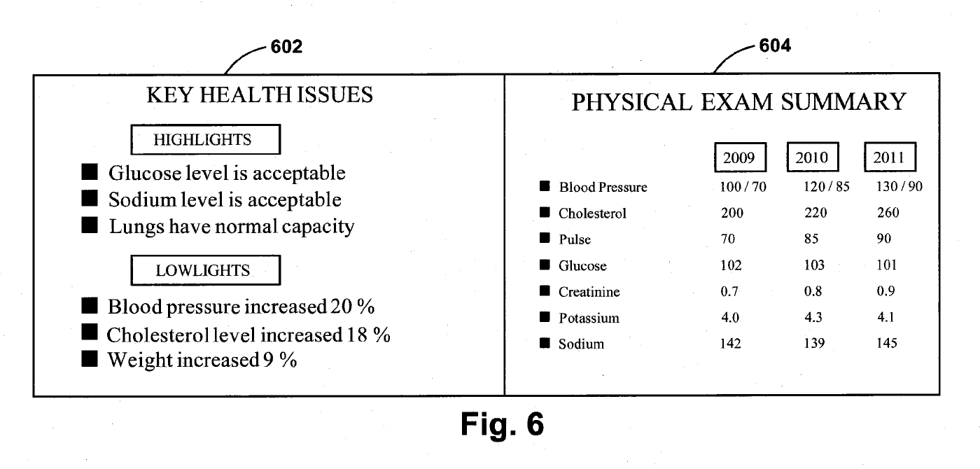

FIG. 6 illustrates another example record output including a structured report of key health issues 602. It will be appreciated from the example that issues are placed in easily-understood and discernible categories, including highlights, or good status levels and lowlights or bad status levels. A physical exam summary 602 is shown with representative measurements illustrated over time. Such a report structure facilities an easy understating as to how health indicators progress or degrade.

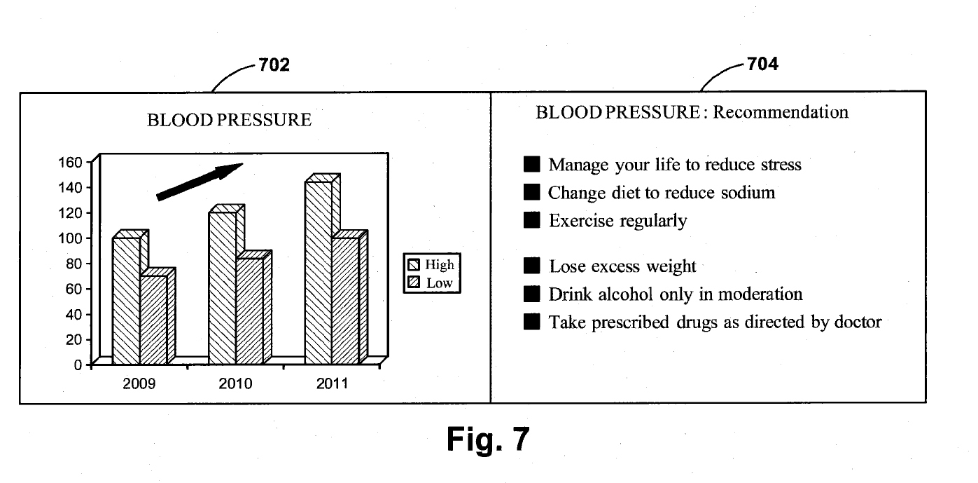

FIG. 7 illustrates a graphic output 702 structured to easily illustrate blood pressure highs and lows, and an arrow indicated of trend analysis, in years in the illustrated embodiment. Also illustrated are recommendations that relate to the graphic output 702, and provide immediate guidance as to how to address related concerns.

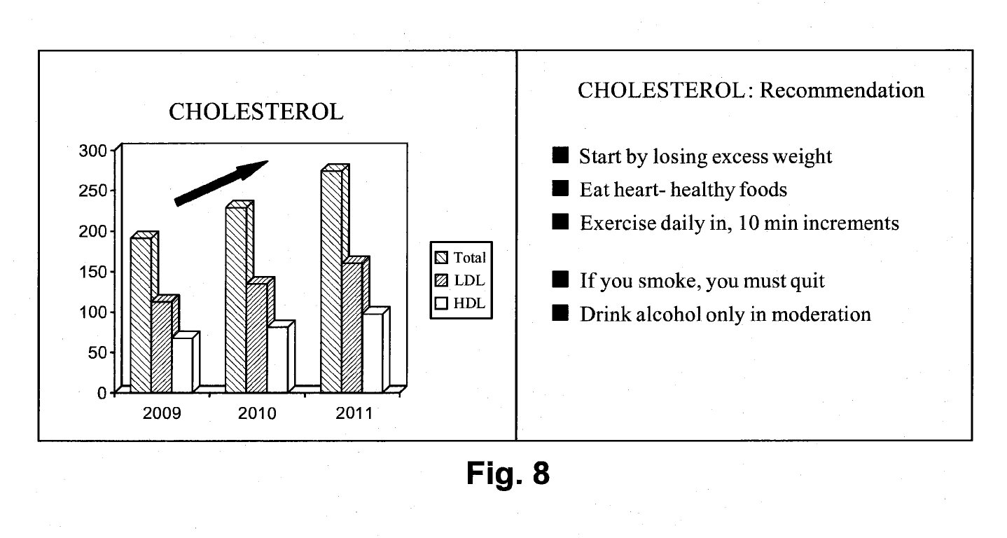

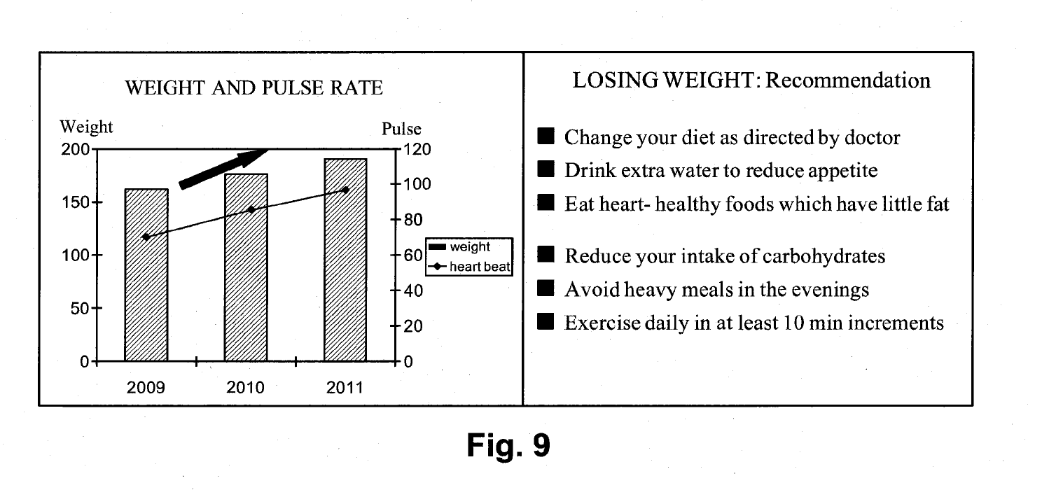

FIGS. 8-9 are analogous to that of FIG. 7, and provide indicators and recommendations as to cholesterol and weight, respectively.

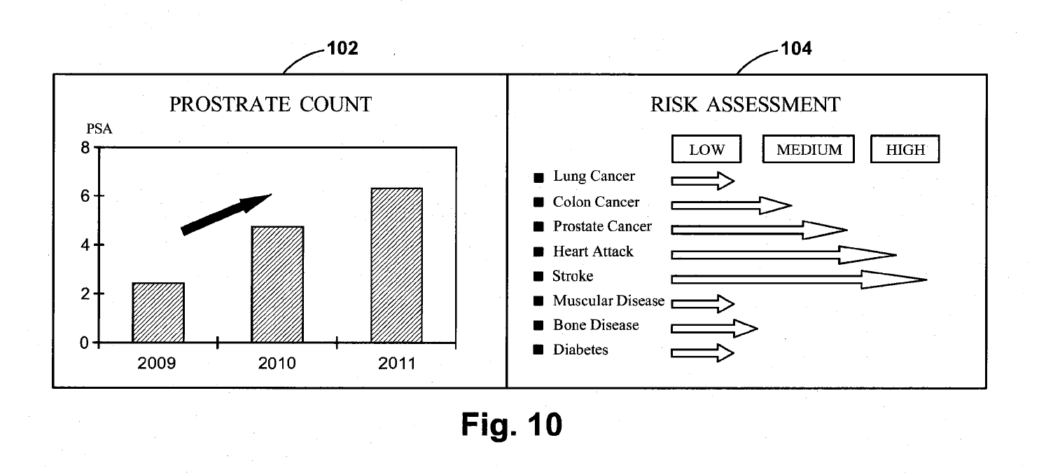

FIG. 10 provides further variation to a report format or output, and includes graphic trend data relative to a prostate count. Risk assessment portion 104 provides a readily understandable risk assessment wherein length or color of arrows correspond to risk levels given the values and trends illustrated at 102.

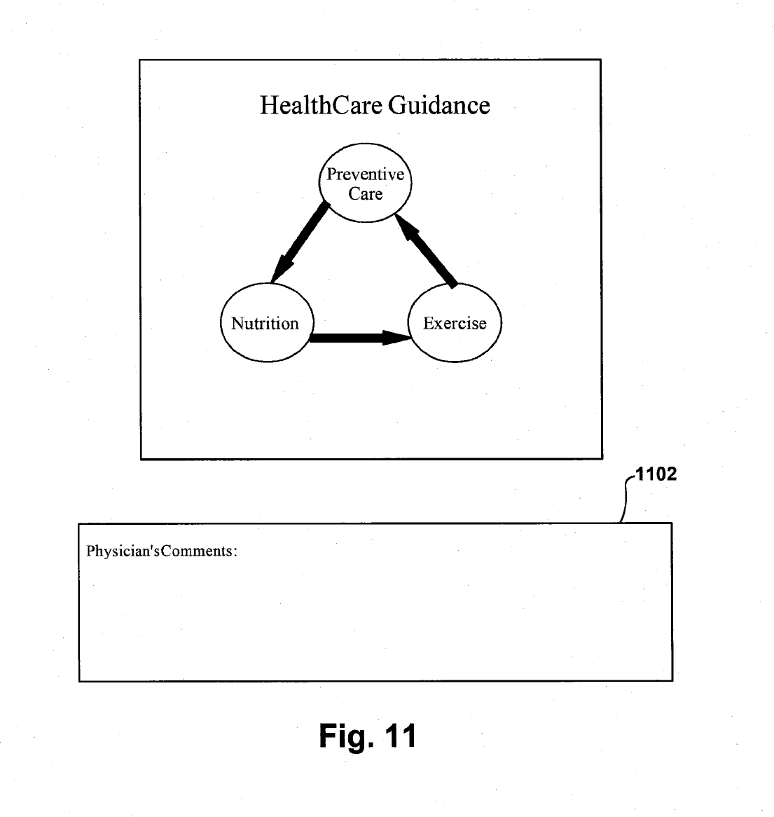

FIG. 11 illustrates an embodiment of an output showing a balanced healthcare guidance, and includes a data input or display area 1102 that allows of addition of notes or other indicia or data added by a physician or other healthcare provider.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. A healthcare system comprising:
an input operative to receive, from a third-party medical data source, medical data associated with an individual, the medical data including multiple instances of related data associated with the individual over time;
a data storage operative to store received medical data;
the data storage further operative to store formatting data corresponding to at least one preselected data presentation format;
logic operative to analyze the medical data for trends exhibited over time with the multiple instances of related data;
logic operative to determine a risk level of the individual in accordance with analysis of the medical data;
logic operative to generate reports in accordance with the analyzed medical data;
logic operative to format generated reports in accordance with the formatting data; and
an output operable to display formatted reports to the individual.

2. The system of claim 1 wherein the input is further operative to receive the medical data inclusive of clinical data associated with an exam.

3. The system of claim 1 wherein:
the logic is operative to identify peer group data associated with the individual;
the logic is operative to compare the medical data to identified peer group data;
the logic is operative to generate a health score in accordance with the comparison; and
wherein the output is operable to display the health score.

4. The system of claim 1 wherein:
the logic is operative to retrieve remedial data corresponding to analyzed medical data; and
the output is operable to display the retrieved remedial data.

5. The system of claim 1 further comprising:
a network interface operable to communicate data to an associated data network; and
wherein the logic is operative to communicate data corresponding to the formatted report to the associated data network via the network interface.

6. The system of claim 2 wherein the input is further operable to receive the medical data inclusive of direct input from the individual.

7. The system of claim 1 logic is further operable to determine the risk level in accordance with iterative application of the medical data to data corresponding to pre-selected what-if scenarios.

8. A healthcare method comprising:
receiving, from a third-party medical data source, medical data associated with an individual, the medical data including multiple instances of related data associated with the individual over time;
storing received medical data in an associated data storage;
storing, in the data storage, formatting data corresponding to at least one preselected data presentation format;
analyzing the medical data relative for trends exhibited over time with the multiple instances of related data;
determining a risk level of the individual in accordance with analysis of the medical data;
generating reports in accordance with the analyzed medical data;
formatting the generated reports in accordance with the formatting data; and
displaying formatted reports to the individual.

9. The method of claim 1 wherein the input is further comprising receiving the medical data inclusive of clinical data associated with an exam.

10. The method of claim 1 further comprising:
Identifying a peer group data associated with the individual;
comparing the medical data to identified peer group data;
generating a health score in accordance with the comparison; and
displaying the health score.

11. The method of claim 1 further comprising:
retrieving remedial data corresponding to analyzed medical data; and
displaying the retrieved remedial data.

12. The method of claim 1 further comprising:
communicating data to an associated data network; and
communicating data corresponding to the formatted report to the associated data network via the network interface.

13. The method of claim 2 further comprising receiving the medical data inclusive of direct input from the individual.

14. The method of claim 1 logic is further comprising determining the risk level in accordance with iterative application of the medical data to data corresponding to pre-selected what-if scenarios.

15. A healthcare system comprising:
an input operative to receive, from a health care provider, medical data associated with an individual, the medical data including multiple instances of related data associated with the individual over time, the medical data further including physical exam data associated with a physical exam of the individual and lab data associated with lab test results associated with the individual;
a data storage operative to store received medical data;
the data storage further operative to store formatting data corresponding to at least one preselected data presentation format;
logic operative to analyze the medical data for trends exhibited over time with the multiple instances of related data;
logic operative to determine a risk level of the individual in accordance with a statistical analysis of the medical data;
logic operative to generate reports in accordance with the analyzed medical data;
logic operative to format generated reports in accordance with the formatting data; and
an output operable to communicate formatted reports to an associated web client in accordance with a web session initiated by the individual.

16. The system of claim 15 further comprising logic operative to generate an alert in accordance with analyzed medical data and the risk level.

17. The system of claim 16 further comprising logic to generate the alert to the web client.

18. The system of claim 17 further comprising logic to generate the alert to an associated medical care provider.

19. The system of claim 18 further comprising logic to communicate the medical data to the associated medical care provider.

20. The system of claim 19 further comprising logic to generate the reports in accordance with peer group data corresponding to the individual.
